(19) United States
(12) Patent Application Publication
(10) Pub. No.: US 2010/0041822 A1
(43) Pub. Date: Feb. 18, 2010

(54) CROSSLINKABLE REACTIVE SILICONE ORGANIC COPOLYMERS AND METHOD FOR THE PRODUCTION AND USE THEREOF

(75) Inventor: Abdulmajid Hashemzadeh, Burgkirchen (DE)

Correspondence Address: RATNERPRESTIA, P.O. BOX 980, VALLEY FORGE, PA, 19482, US

(73) Assignee: Wacker Chemie AG, Munchen (DE)

(21) Appl. No.: 12/375,150

(22) PCT Filed: Aug. 7, 2007
(86) PCT No.: PCT/EP2007/058190

§ 371 Date: Sep. 30, 2009

(30) Foreign Application Priority Data
Sep. 9, 2006 (DE) 10 2006 037 271.9

(51) Int. Cl. C08L 83/04; C08G 77/04; C08F 30/08; C08F 30/02

(52) U.S. Cl. 524/588; 528/25; 528/26; 526/279; 526/278

(57) ABSTRACT

The invention relates to crosslinkable reactive silicone organic copolymers, obtainable by the radically initiated solution polymerization of a) one or more ethylenically unsaturated organic monomers, and b) one or more silicon macromers, characterized in that c) one or more ethylenically unsaturated monomers containing at least one further functional group is or are copolymerized in an organic solvent or solvent mixture and that monomer units c) of the prepolymers thus obtained are bonded by polymer analog reaction with one or more additional monomers in such a way that at least one crosslinkable reactive group is introduced in the silicone organic copolymers.

The invention relates to highly transparent silicone organic copolymers which are functionalized with crosslinkable reactive groups, to processes for preparing them, and for their use as reactive crosslinkers.

The incorporation of reactive groups into silicones for the purpose of preparing reactive crosslinkers is described in U.S. Pat. No. 5,618,879. Accordingly, for example, acrylate-substituted silicones can be crosslinked or polymerized, free-radically, by irradiation with UV or electrons. Silicones modified in this way find application, for example, in compositions for hydrophobicizers.

Silicone-containing formulations, however, have a range of disadvantages. For instance, within formulations, silicone components tend to migrate and, consequently, to cause separation of the composition (Chemistry & Technology of UV & EB formulation for coatings, Inks & Paints, Volume V, 1996, John Wiley & Sons, ISBN 094 7798 374). Furthermore, silicones possess a high surface tack, leading to dirt pickup or to the sticking of substrates. Through contamination of silicone-coated substrate surfaces, their film adhesion is strongly adversely affected, and this is of critical significance, for example, for coatings or adhesives. For silicones, furthermore, plasticizer effects and limited solubility in solvents such as alcohols, for example, are characteristic.

A further problem lies in the provision of highly transparent, dispersible silicone organic copolymer compositions having a high silicone fraction. Particularly in the case of the preparation of silicone organic copolymers having a silicone fraction of above 20% by weight, the poor compatibility of olefinic monomers and silicones results in problems at the free-radical polymerization stage, through phase separation or gelling, and this leads to the clouding of the silicone organic copolymers.

In order to obtain dispersible compositions of silicone organic copolymers, it is necessary for emulsifiers or protective colloids to be present during their preparation by copolymerization of silicone macromers and organic monomers.

Accordingly, in EP-A 810243 and JP-A 05-009248, silicone macromers are polymerized with organic monomers in the presence of emulsifiers in emulsion, the procedures operating exclusively with oil-soluble initiator. A disadvantage of the process involving initiating with oil-soluble initiator is the inadequate stability of the resultant dispersions, which show a very strong propensity toward phase separation.

EP-A 352339 describes a process for preparing silicone organic copolymers by means of solution polymerization that involves introducing the silicone fraction in the solvent as an initial charge and continuously metering in a mixture of monomers and oil-soluble initiator. The copolymers obtainable in this way, however, are not dispersible in water. Dispersing these copolymers requires dispersing assistants such as emulsifiers or protective colloids.

The silicone organic copolymer compositions obtainable in this way, however, have a propensity toward phase separation. Phase separation during the polymerization leads to cloudy polymer films. Migration of the emulsifiers or protective colloids in silicone organic copolymer compositions has an adverse influence, as is known, on the water resistance, adhesion or stability properties of the silicone organic copolymer compositions.

Against this background, the object was to provide crosslinkable, reactive, silicone-containing polymers which exhibit no plasticizer effects or surface tack and which in formulations do not have the abovementioned migration tendencies typical of silicones. The intention was also, furthermore, to provide crosslinkable, reactive silicone-containing polymers which are self-dispersible in water, without emulsifiers or protective colloids, and/or which are highly transparent even with silicone contents of ≧20% by weight.

The invention provides crosslinkable reactive silicone organic copolymers, obtainable by means of free-radically initiated solution polymerization of a) one or more ethylenically unsaturated organic monomers, and

b) one or more silicone macromers, characterized in that

c) one or more ethylenically unsaturated monomers containing at least one further functional group are copolymerized in an organic solvent or solvent mixture, and monomer units c) of the resulting prepolymers are linked, by polymer-analogous reaction, with one or more further monomers c), in such a way that at least one crosslinkable reactive group is introduced into silicone organic copolymers.

The prepolymers for reactive crosslinkable silicone organic copolymers are prepared by means of free-radical solution polymerization in the presence of free-radical initiators in an organic solvent or in a mixture of organic solvents, or in a mixture of one or more organic solvents and water.

Preferred solvents or preferred solvent components in solvent mixtures are selected from the class of the alcohols, esters, ethers, aliphatic hydrocarbons or aromatic hydrocarbons.

Particularly preferred solvents are aliphatic alcohols having 1 to 6 C atoms such as methanol, ethanol, propanol or isopropanol and also their mixtures with water. Most preference is given to isopropanol and its mixtures with aliphatic alcohols having 1 to 6 C atoms or water.

In the case of the preparation of silicone organic copolymers with silicone contents of ≧20% by weight, based on the total weight of components a) to c), it is preferred to use solvents or solvent mixtures which are nonsolvents for silicone macromer b), and solvents for the monomers a) and c). Silicone macromer b) is soluble therein at less than 5% by weight and the monomers a) and c) are soluble therein at more than 5% by weight each under standard conditions (23/50) in accordance with DIN 50014.

A preferred solvent for the preparation of silicone organic copolymers with silicone contents of ≧20% by weight is isopropanol. Also preferred for this purpose are mixtures of solvents consisting of isopropanol and one or more solvents selected from the group encompassing alcohols having 1 to 6 C atoms and water. Particularly preferred solvent mixtures are isopropanol and ethanol or isopropanol and propanol or isopropanol and water.

As ethylenically unsaturated organic monomers a) in the polymerization it is preferred to use one or more monomers from the group encompassing vinyl esters of unbranched or branched alkylcarboxylic acids having 1 to 15 C atoms, methacrylic esters and acrylic esters of unbranched or branched alcohols having 1 to 15 C atoms, vinylaromatics, olefins, dienes and vinyl halides.

In general, 5% to 95% by weight of ethylenically unsaturated organic monomers a) are used, preferably 20% to 80% by weight, based in each case on the total weight of components a) to c).

Preferred vinyl esters are vinyl esters of unbranched or branched carboxylic acids having 1 to 15 C atoms. Particularly preferred vinyl esters are vinyl acetate, vinyl propionate, vinyl butyrate, vinyl 2-ethylhexanoate, vinyl laurate, 1-methylvinyl acetate, vinyl pivalate and vinyl esters of α-branched monocarboxylic acids having 5 to 13 C atoms, such as, for example VeoVa5^{R}, VeoVa9^{R}, VeoVa10^{R}, or VeoVa11^{R} (trade names of the company Shell). The most preferred is vinyl acetate.

Preferred organic monomers a) from the group of the esters of acrylic acid or methacrylic acid are esters of unbranched or branched alcohols having from 1 to 15 C atoms. Particularly preferred methacrylic esters or acrylic esters are methyl acrylate, methyl methacrylate, ethyl acrylate, ethyl methacrylate, propyl acrylate, propyl methacrylate, n, iso- and tert-butyl acrylate, n, iso- and tert-butyl methacrylate, 2-ethylhexyl acrylate, norbornyl acrylate. Most preferred are methyl acrylate, methyl methacrylate, n, iso- and tert-butyl acrylate, 2-ethylhexyl acrylate and norbornyl acrylate.

Preferred dienes are 1,3-butadiene and isoprene. Examples of copolymerizable olefins are ethene and propene. Vinylaromatics which can be copolymerized are styrene and vinyltoluene. From the group of the vinyl halides it is usual to use vinyl chloride, vinylidene chloride or vinyl fluoride, preferably vinyl chloride.

Preferred silicone macromers b) are linear, branched, cyclic and three-dimensionally crosslinked silicones (polysiloxanes) having at least 10 repeating siloxane units and having at least one free-radically polymerizable functional group. The chain length is preferably 10 to 1000 repeating siloxane units. With particular preference, the chain length is 25 to 1000 repeating siloxane units. Ethylenically unsaturated groups such as alkenyl groups are preferred as polymerizable functional groups. The silicone fraction in the copolymer composed of components a-c) is preferably 5% to 80%, more preferably 15% to 60%, most preferably 30% to 60%, by weight based in each case on the total weight of the copolymer composed of components a-c).

Preferred silica macromers b) are silicones having the general formula R¹ₐR₃₋ₐSiO(SiR₂O)ₙSiR₃₋ₐR¹ₐ where each R is identical or different and is a monovalent, optionally substituted alkyl radical or alkoxy radical having in each case 1 to 18 C atoms, R¹ is a polymerizable group, a is 0 or 1, and n is 10 to 1000.

In the general formula R¹ₐR₃₋ₐSiO(SiR₂O)ₙSiR₃₋ₐR¹ₐ, examples of radicals R are methyl, ethyl, n-propyl, isopropyl, 1-n-butyl, 2-n-butyl, isobutyl, tert-butyl, n-pentyl, isopentyl, neopentyl, tert-pentyl radical, hexyl radicals, such as the n-hexyl radical, heptyl radicals such as the n-heptyl radical, octyl radicals such as the n-octyl radical and isooctyl radicals such as the 2,2,4-trimethylpentyl radical, nonyl radicals such as the n-nonyl radical, decyl radicals such as the n-decyl radical, dodecyl radicals such as the n-dodecyl radical, and octadecyl radicals such as the n-octadecyl radical, cycloalkyl radicals such as cyclopentyl, cyclohexyl, cycloheptyl, and methylcyclohexyl radicals. Preferably the radical R is a monovalent hydrocarbon radical having 1 to 6 carbon atoms, such as methyl, ethyl, n-propyl, isopropyl, n-butyl, sec-butyl, amyl and hexyl radical, the methyl radical being particularly preferred.

Preferred alkoxy radicals R are those having 1 to 6 carbon atoms such as methoxy, ethoxy, propoxy and n-butoxy radical, which optionally may also be substituted by oxyalkylene radicals such as oxyethylene or oxymethylene radicals. Particular preference is given to the methoxy and ethoxy radical. The stated alkyl radicals and alkoxy radicals R optionally may also be substituted, as for example, by halogen, mercapto groups, epoxy-functional groups, carboxyl groups, keto groups, enamine groups, amino groups, aminoethylamino groups, isocyanato groups, aryloxy groups, alkoxysilyl groups, and hydroxyl groups.

Suitable polymerizable groups R¹ are alkenyl radicals having 2 to 8 C atoms. Examples of such polymerizable groups are the vinyl, allyl, butenyl, and also acryloyloxyalkyl and methacryloyloxyalkyl group, the alkyl radicals containing 1 to 4 C atoms. Preference is given to the vinyl group, 3-methacryloyloxypropyl, acryloyloxymethyl, and 3-acryloyloxypropyl group.

Preference is given to α,ω-divinyl-polydimethylsiloxanes, α,ω-di(3-acryloyloxypropyl)polydimethylsiloxanes, α,ω-di(3-methacryloyloxypropyl)polydimethylsiloxanes. In the case of the silicones substituted only once by unsaturated groups, preference is given to α-monovinyl-polydimethylsiloxanes, α-mono(3-acryoyloxypropyl)polydimethylsiloxanes, α-mono(acryloyloxymethyl)polydimethylsiloxanes, α-mono(3-methacryloyloxypropyl)polydimethylsiloxanes. In the case of the monofunctional polydimethylsiloxanes there is an alkyl or alkoxy radical located at the other end of the chain, a methyl or butyl radical, for example.

Preference is also given to mixtures of linear or branched divinyl-polydimethylsiloxanes with linear or branched monovinyl-polydimethylsiloxanes and/or unfunctionalized polydimethylsiloxanes (the latter possessing no polymerizable group). The vinyl groups are located at the end of the chain. Examples of mixtures of this kind are silicones of the solvent-free Dehesive®-6 series (branched) or Dehesive®-9 series (unbranched) from Wacker Chemie AG. In the case of the binary or ternary mixtures, the fraction of the nonfunctional polydialkylsiloxanes is up to 15% by weight, preferably up to 5% by weight; the fraction of the monofunctional polydialkylsiloxanes is up to 50% by weight; and the fraction of the difunctional polydialkylsiloxanes is at least 50% by weight, preferably at least 60% by weight, based in each case on the total weight of the silicone macromer.

Most preferred as silicone macromers b) are α,ω-divinyl-polydimethylsiloxanes.

Preferred monomers c) used are the following monomers, which are referred to below as nucleophilic monomers c): ethylenically unsaturated monocarboxylic and dicarboxylic acids or their salts, preferably crotonic acid, acrylic acid, methacrylic acid, fumaric acid or maleic acid;

monoesters of fumaric acid or of maleic acid, preferably their ethyl or isopropyl esters; ethylenically unsaturated sulfonic acids or their salts, preferably vinylsulfonic acid, 2-acrylamido-2-methylpropanesulphonic acid; ethylenically unsaturated alcohols, preferably 2-hydroxyethyl methacrylate, hydroxypropyl methacrylate, 2-hydroxyethyl acrylate, hydroxypropyl acrylate, or glycerol 1-allyl ether; ethylenically unsaturated primary, secondary or tertiary amines, preferably 2-dimethylaminoethyl methacrylate, 2-tert-butylaminoethyl methacrylate, allyl N-(2-aminoethyl)carbamate hydrochloride, allyl N-(6-aminohexyl)carbamate hydrochloride, allyl N-(3-aminopropyl) hydrochloride, allylamine or vinylpyridine; ethylenically unsaturated amides, preferably 3-dimethylaminopropylmethacrylamide, 3-trimethylammoniumpropylmethacrylamide chloride; phosphonic acids or their salts, preferably vinylphosphonic acid, SIPOMER PAM-100^{R} or SIPOMER-200^{R} (trade names of the company Rhodia).

Preferred monomers c) are also the following monomers, which are referred to below as electrophilic monomers c): ethylenically unsaturated epoxides, preferably glycidyl methacrylate (GMA); ethylenically unsaturated isocyanates, preferably 1-(isocyanato-1-methyl)-3-(methylethyl)benzene; ethylenically unsaturated anhydrides, preferably maleic anhydride.

Particularly preferred monomers c) are crotonic acid, acrylic acid, methacrylic acid, 2-hydroxyethyl methacrylate, 2-hydroxyethyl acrylate, glycidyl methacrylate (GMA) and 1-(isocyanato-1-methyl)-3-(methylethyl)benzene.

Where nucleophilic monomers c) are used in preparing prepolymers, electrophilic monomers c) should be selected for the subsequent reaction of the prepolymers for the preparation of crosslinkable reactive silicone organic copolymers; and, where electrophilic monomers c) are used for preparing prepolymers, in contrast, nucleophilic monomers c) should be selected for the subsequent reaction of the prepolymers for the preparation of crosslinkable reactive silicone organic copolymers.

Generally speaking, 2% to 15% by weight of monomers c), preferably 4% to 10% by weight, based in each case on the total weight of components a) to c) are used. Of the total monomers c) used to prepare the silicone organic copolymers, it is preferred to use 50 to 75 mol %, more preferably 50 to 67 mol %, to prepare the prepolymer, and to use the remaining 50 to 25 mol % or 50 to 33 mol %, respectively, for the polymer-analogous reaction of the prepolymer with monomer c).

For preparing the silicone organic copolymers it is possible, as well as the monomers a-c), to use auxiliary monomers in addition. Suitable auxiliary monomers are polymerizable silanes and/or mercapto silanes in hydrolyzed form. Preference is given to gamma-acryloyl- and gamma-methacryloyloxypropyltri(alkoxy)silanes, α-methacryloyloxymethyltri(alkoxy)silanes, gamma-methacryloyloxypropylmethyldi(alkoxy)silanes, vinylalkyldi(alkoxy)silanes and vinyltri(alkoxy)silanes, examples of alkoxy groups that can be used being methoxy, ethoxy, methoxyethylene, ethoxyethylene, methoxypropylene glycol ether or ethoxypropylene glycol ether radicals. Examples of such monomers are vinyltrimethoxysilane, vinyltriethoxysilane, vinyltripropoxysilane, vinyltriisopropoxysilane, vinyltris(1-methoxy)isopropoxysilane, vinyltributoxysilane, vinyltriacetoxysilane, 3-methacryloyloxypropyltrimethoxysilane, 3-methacryloyloxypropylmethyldimethoxysilane, methacryloyloxymethyltrimethoxysilane, 3-methacryloyloxypropyltris(2-methoxyethoxy)silane, vinyltrichlorosilane, vinylmethyldichlorosilane, vinyltris(2-methoxyethoxy)silane, trisacetoxyvinylsilane, 3-(triethoxysilyl)propylsuccinic anhydridosilane. Preference is also given to 3-mercaptopropyltriethyoxysilane, 3-mercaptopropyltrimethoxysilane and 3-mercaptopropylmethyldimethoxysilane.

The auxiliary monomers are used in general at a fraction of up to 10% by weight, based on the total weight of the organic monomers a).

Preferred silicone organic copolymers are those obtainable by means of free-radically initiated solution polymerization of one or more organic monomers a) selected from the group encompassing vinyl acetate, vinyl laurate, VeoVa5^{R}, VeoVa9^{R}, VeoVa10^{R} and VeoVa11^{R}, and one or more silicone macromers b) selected from the group encompassing α,ω-divinyl-polydimethylsiloxane, α,ω-di(3-acryloyloxypropyl)polydimethylsiloxane, and α,ω-di(3-methacryloyloxypropyl)polydimethylsiloxane, and one or more monomers c) selected from the group encompassing crotonic acid, acrylic acid, methacrylic acid, 2-hydroxyethyl methacrylate, 2-hydroxyethyl acrylate, glycidyl methacrylate (GMA) and 1-(isocyanato-1-methyl)-3-(methylethyl)benzene, and optionally, one or more additional auxiliary monomers and optionally ethylene, and polymer-analogous reaction of the resultant prepolymers with one or more suitable monomers c) selected from the group encompassing crotonic acid, acrylic acid, methacrylic acid, 2-hydroxyethyl methacrylate, 2-hydroxyethyl acrylate, glycidyl methacrylate (GMA) and 1-(isocyanato-1-methyl)-3-(methylethyl)benzene.

Suitability is possessed by electrophilic monomers c), for polymer-analogous reactions, provided prepolymers contain nucleophilic monomer units c). Correspondingly, nucleophilic monomers c) are suitable for polymer-analogous reactions provided prepolymers contain electrophilic monomer units c).

The invention further provides a process for preparing crosslinkable reactive silicone organic copolymers, obtainable by means of free-radically initiated solution polymerization of a) one or more ethylenically unsaturated organic monomers, and b) one or more silicone macromers, characterized in that

c) one or more ethylenically unsaturated monomers containing at least one further functional group are copolymerized in an organic solvent or solvent mixture, and monomer units c) of the resulting prepolymers are linked, by polymer-analogous reaction with one or more further monomers c), in such a way that at least one crosslinkable reactive group is introduced into silicone organic copolymers.

The reaction temperature for the preparation of the prepolymers for reactive crosslinkable silicone organic copolymers is 20° C. to 100° C., preferably 40° C. to 80° C. Generally speaking, polymerization takes place under reflux at atmosphere pressure. In the case of the copolymerization of monomers which are gaseous at room temperature, such as ethylene, the polymerization is operated under pressure, generally at between 1 and 100 bar.

Generally speaking, the polymerization is carried out to a solids content of 15% to 90%, preferably to a solids content of 40% to 80%.

Suitable free-radical initiators are oil-soluble initiators, such as tert-butyl peroxy-2-ethylhexanoate, tert-butyl peroxypivalate, tert-butyl peroxyneodecanoate, dibenzoyl peroxide, tert-amyl peroxypivalate, di(2-ethylhexyl) peroxydicarbonate, 1,1-bis(tert-butylperoxy)-3,3,5-trimethylcyclohexane, and di(4-tert-butylcyclohexyl) peroxydicarbonate. Also suitable are azo initiators such as azobis-isobutyronitrile. The initiators generally are used in an amount of 0.005% to 3.0% by weight, preferably 0.1% to 1.5% by weight, based in each case on total weight of monomers a-c).

The setting of the molecular weight and of the degree of polymerization is known to a person skilled in the art. It can be accomplished, for example, by addition of regulator, by the ratio of solvent to monomers, by variation of the initiator concentration, by varied metering of monomers, and by variation of the temperature. Regulators or chain transfer agents are, for example, acetaldehyde or compounds containing mercapto groups, such as dodecyl mercaptan or silicones containing mercapto groups.

The polymerization can be carried out with all or certain constituents of the reaction mixture being included in the initial charge, or with some being included in the initial charge and some of the constituents, or of certain constituents, of the reaction mixture being metered in subsequently, or else by the metering method without an initial charge. The preferred approach is to include all of the polydimethylsiloxane, a portion of the monomers, solvent and a portion of the initiator in the initial charge and to meter in the remainder of the monomers and of the initiator.

As a batch process, all of the monomers, solvent and a portion of the initiator are included in the initial charge and the remainder of the initiator is metered in or added in portions.

After the end of polymerization, post-polymerization may be carried out, using known methods, for the purpose of removing residual monomers. Volatile residual monomers and other volatile constituents may also be removed by means of distillation or stripping methods, preferably under reduced pressure.

Polymer-analogous reaction of the prepolymers prepared from the monomers a-c) with further monomers c) results, finally, in crosslinkable reactive silicone organic copolymers.

Polymer-analogous reactions may take place directly in the solvents or solvent mixtures in which the corresponding prepolymers are prepared, provided the monomers c) chosen for polymer-analogous reactions are sufficiently stable in these solvents or solvent mixtures. Otherwise, after preparation of the prepolymers, the solvent or the solvent mixture can be removed and, following the addition of an inert solvent or solvent mixture, the polymer-analogous reaction can be carried out. Suitable inert solvents or solvent components in solvent mixtures for polymer-analogous reactions are aliphatic or aromatic hydrocarbons, ethers or esters, preferably xylene, toluene or butyl acetate.

Alternatively it is also possible for polymer-analogous reactions of prepolymers with monomers c) to take place in the melt. For that purpose the solvents or solvent mixtures used for preparing the corresponding prepolymers are removed prior to the polymer-analogous reaction. Preconditions for reactions in the melt are melt viscosities on the part of the polymers of ≦800 Pa·s at 100° C.

Polymer-analogous reactions are carried out preferably in a temperature range between 40 and 140° C., preferably between 90 and 120° C.

The glass transition temperature and the molecular weight of the crosslinkable reactive silicone organic copolymers can be adjusted in a known way through the composition of components a-c) and of the polymerization conditions such as, for example, solvents, initiator concentration, polymerization temperature and regulator. The molecular weight is preferably ≧3500 g/mol and more preferably between 3500 and 100 000 g/mol. At such molecular weights there are no problems due to phase separation or migration. The compatibility of silicone organic copolymers can be adjusted through the selection of the monomers and also through weight % fractions of the monomer units in silicone copolymers, in a targeted way.

In one alternative embodiment of the polymer-analogous reaction, the functional groups of the monomer units c) in the prepolymer are not reacted completely with further monomers c), and so partly modified crosslinkable reactive silicone organic copolymers having different reactive functional groups are formed. Besides the olefinic radicals which are introduced through reaction of the prepolymer with monomer c), in partly modified silicone organic copolymers, additionally, the unreacted functional groups of the monomer units c) in the prepolymer are present, i.e., carboxylic acid groups or their salts, sulfonic acid groups or their salts, alcohol groups, amine groups, amide groups, phosphonic acid groups or their salts, epoxide groups, isocyanate groups or anhydride groups.

On account of their different functional groups, partly modified silicone organic copolymers can be linked to substrates with dual crosslinking. By dual crosslinking is meant the incidence of two different crosslinking mechanisms, such as free-radical and thermal crosslinking mechanisms for example. These different crosslinking mechanisms may occur simultaneously or successively. In this way it is possible to influence the adhesion properties of the silicone copolymers on substrates.

Furthermore, partly modified silicone organic copolymers obtainable in this way are self-dispersible in water without emulsifiers, protective colloids or other auxiliaries.

On account of their reactivity, the crosslinkable reactive silicone organic copolymers feature high crosslinking rates, thus producing a very rapid increase in viscosity during crosslinking. The crosslinking rate may be controlled through the half-lives of the initiators, through use of initiator accelerators, or through the concentration of initiator. Initiators used for UV crosslinking are the UV initiators that are known to a person skilled in the art.

The crosslinkable reactive silicone organic copolymers are able to crosslink with themselves or with other organic or inorganic compounds through addition of initiators or catalysts. The crosslinking may also be brought about by electron beam irradiation or, in the presence of suitable initiators, by UV radiation. Crosslinking takes place at room temperature or at an elevated temperature.

The silicone organic copolymers are suitable as release agents and coating materials. For example, for the production of water- and dirt-repellant surfaces. They are also suitable for the coating of textiles, paper, films, and metals, as a protective coating or as an antifouling coating, for example. A further field of application is that of architectural preservation, particularly for the production of weathering-resistant coatings or sealants. They are also suitable as modifiers and hydrophobicizers, and as additives in the processing of plastics and the packaging industry and are able, for example, to constitute an oxygen barrier.

The examples which follow serve to illustrate the invention further, without restricting it in any way.

### Raw Materials:

Polydimethylsiloxane (PDMS) having about 100, 133 and 177 SiOMe₂ repeating units, α,ω-divinyl functionalized (VIPO 200, 300 and 500)

Manufacturer: Wacker Chemie AG

### PREPARATION OF PREPOLYMERS

### Example 1

A 21 stirred glass pot with anchor stirrer, reflux condenser and metering devices was charged with 407.0 g of isopropanol, 182.4 g of PDMS mixture, 152.0 g of vinyl acetate and 1.6 g of PPV (tert-butyl perpivalate, 75% strength solution in aliphatics). Subsequently, the initial charge was heated to 75° C. under nitrogen at a stirrer speed of 200 rpm. When the internal temperature of 75° C. had been reached 413.6 g of vinyl acetate, 109.6 g of vinyl laurate, 55 g of crotonic acid and initiator solution (70 g of isopropanol and 13.3 g of PPV) were metered in. The monomer solution was metered in over the course of 120 minutes and the initiator solution over the course of 180 minutes. After the end of the initiator feeds, post-polymerization took place for a further two hours at 80° C. This gave a clear polymer solution having a solids content of 65% by weight. Under vacuum and at elevated temperature, isopropanol was distilled off. The dry film from ethyl acetate solution (film thickness 70 micrometers) was clear.

### Example 2

A 21 stirred glass pot with anchor stirrer, reflux condenser and metering devices was charged with 770.0 g of butyl acetate, 140.3 g of PDMS mixture, 117.0 g of vinyl acetate and 1.2 g of PPV (tert-butyl perpivalate, 75% strength solution in aliphatics). Subsequently, the initial charge was heated to 75° C. under nitrogen at a stirrer speed of 200 rpm. When the internal temperature of 75° C. had been reached 318.1 g of vinyl acetate, 84.3 g of vinyl laurate, 42.3 g of crotonic acid and initiator solution (70 g of butyl acetate and 13.3 g of PPV) were metered in. The monomer solution was metered in over the course of 120 minutes and the initiator solution over the course of 180 minutes. After the end of the initiator feeds, post-polymerization took place for a further two hours at 80° C. This gave an almost clear polymer solution having a solids content of 45% by weight. The dry film from butyl acetate solution (film thickness 70 micrometers) was clear.

### Polymer Analogous Reactions

### Example 3

### Polymer-analogous Reaction in the Melt

The base resin was modified by isolating the carboxyl-containing organic silicone copolymer from example 1 (200 g), melting it in a reactor at 110° C., adding 0.4 g of catalyst (triphenylphosphine) and 0.1 g of inhibitor (hydroquinone), and stirring the mixture for about 15 minutes. Thereafter 20 g of glycidyl methacrylate were metered into the reactor over the course of 30 minutes. After about 4 hours, the volatile constituents were removed under vacuum and the melt was cooled.

### Example 4

### Polymer-analogous Reaction in the Melt, with Partial Modification of the Prepolymer

The experiment was carried out in the same way as for example 3, but with the amount of glycidyl methacrylate reduced to 12 g.

### Dispersing:

30 g of isolated product from example 4, and ammonia solution as neutralizing agent, were added with stirring to 70 g of hot water (temperature 40-80° C.), so that the pH did not fall below 8. After about 3 hours a stable dispersion was obtained.

### Example 5

### Polymer-analogous Reaction in a Solvent

The base resin was modified by mixing the carboxyl-containing organic silicone copolymer solution from example 2 (445 g) in a reactor at 110° C., with 0.4 g of catalyst (triphenylphosphine), 0.1 g of inhibitor (hydroquinone), and the mixture was stirred for about 15 minutes. Thereafter 20 g of glycidyl methacrylate were metered into the reactor over the course of 30 minutes. After about 10 hours, the volatile constituents were removed under vacuum and the product was isolated.

### Investigation of the Crosslinking Rate or Reactivity of Silicone Organic Copolymers:

The crosslinking rates and reactivities of silicone organic copolymers correlate macroscopically with changes in viscosity during crosslinking.

To demonstrate the high crosslinking rates and high reactivities of silicone organic copolymers of the invention, the crosslinkable, reactive silicone organic copolymer from example 3, and the prepolymer from example 1, were each mixed with 1% by weight of initiator TBPEH based on the copolymer, and the mixtures were dried under vacuum at 30° C. (TBPEH=tert-butyl peroxy-2-ethylhexanoate, 10% strength in isopropanol; half-life at 100° C.: 20 minutes).

The crosslinking was subsequently performed under isothermal reaction conditions at a temperature of 100° C. The increase in viscosity in the course of crosslinking was determined by means of a melt rheology measurement using the Bohlin CVO 120 HR instrument. The plate/plate measuring system was chosen. The complex melt viscosity was measured by means of oscillating measurement at a frequency of 1 Hz and at constant temperature.

The ratio formed from the initial melt viscosity and viscosities during crosslinking is a measure of the degree of crosslinking and hence of the reactivity of the silicone organic copolymers:

Crosslinking of silicone organic copolymer from example 3 at 100° C.:

$$\frac{Melt viscosity after 10 min at 100 ° C .}{Initial melt viscosity} = 180$$

Comparative measurement with prepolymer from example 1 at 100° C.:

$$\frac{Melt viscosity after 10 min at 100 ° C .}{Initial melt viscosity} = 1$$

Through comparison of the two measurements, the high and rapid increase in viscosity of the inventive composition in the course of crosslinking becomes clear. This is a demonstration of the high crosslinking rate and reactivity of silicone organic copolymers of the invention.

The reactivity and crosslinking rate can be shortened significantly through the initiator concentration and through initiators with a low half-life, or by using initiator accelerators.

Initiators used for the UV crosslinking are UV initiators which are known to a person skilled in the art.

1. Crosslinkable reactive silicone organic copolymers, obtainable by means of free-radically initiated solution polymerization of
a) one or more ethylenically unsaturated organic monomers, and b) one or more silicone macromers, characterized in that
c) one or more ethylenically unsaturated monomers containing at least one further functional group are copolymerized in an organic solvent or solvent mixture,
and monomer units c) of the resulting prepolymers are linked, by polymer-analogous reaction with one or more further monomers c), in such a way that at least one crosslinkable reactive group is introduced into silicone organic copolymers.

2. The crosslinkable reactive silicone organic copolymers of claim 1, characterized in that the copolymerization of the monomers a-c) takes place in a solvent or a solvent mixture in which the silicone macromer b) has a solubility of less than 5% by weight under standard conditions.

3. The crosslinkable reactive silicone organic copolymers of claim 1, characterized in that the amount of silicone macromer b), based on the total weight of components a-c), is ≧20% by weight.

4. The crosslinkable reactive silicone organic copolymers of claim 1, characterized in that, through the polymer-analogous reaction, the functional groups of the monomer units c) of the prepolymer are completely reacted with further monomers c).

5. The crosslinkable reactive silicone organic copolymers of claim 1, characterized in that, through the polymer-analogous reaction, the functional groups of the monomer units c) of the prepolymer are not completely reacted with further monomers c), and so partly modified crosslinkable reactive silicone organic copolymers having different reactive functional groups are formed.

6. The crosslinkable reactive silicone organic copolymers of claim 1, characterized in that ethylenically unsaturated organic monomers a) used are vinyl esters of unbranched or branched alkylcarboxylic acids having 1 to 15 C atoms or esters of methacrylic acid or acrylic acid and unbranched or branched alcohols having 1 to 15 C atoms, vinylaromatics, olefins, dienes or vinyl halides.

7. The crosslinkable reactive silicone organic copolymers of claim 1, characterized in that ethylenically unsaturated organic monomers a) used are vinyl acetate, or vinyl acetate and ethylene, or vinyl acetate and vinyl ester of α-branched monocarboxylic acids having 5 to 11 C atoms, or vinyl acetate and VeoVa5^{R} and optionally ethylene, or vinyl acetate and VeoVa9^{R} and optionally ethylene, or vinyl acetate and VeoVa10^{R} and optionally ethylene, or vinyl acetate and VeoVa11^{R} and optionally ethylene, or vinyl acetate and vinyl laurate and optionally ethylene, or ethylene and vinyl ester of α-branched monocarboxylic acids having 5 to 11 C atoms.

8. The crosslinkable reactive silicone organic copolymers of claim 1, characterized in that ethylenically unsaturated organic monomers a) used are one or more from the group encompassing ethyl acrylate, ethyl methacrylate, propyl acrylate, propyl methacrylate, n-, iso- and tert-butyl methacrylate and more preferably methyl acrylate, methyl methacrylate, n-, iso- and tert-butyl acrylate, 2-ethylhexyl acrylate and norbornyl acrylate.

9. The crosslinkable reactive silicone organic copolymers of claim 1, characterized in that silicone macromers b) used are linear, branched, cyclic and three-dimensionally crosslinked silicones having at least 10 repeating siloxane units, and more preferably having 25 to 1000 repeating siloxane units, and having at least one free-radically polymerizable functional group.

10. The crosslinkable reactive silicone organic copolymers of claim 1, characterized in that silicone macromers b) used are silicones of the general formula R¹ₐR₃₋ₐSiO(SiR₂O)ₙSiR₃₋ₐR¹ₐ, where each R is identical or different and is a monovalent, optionally substituted alkyl radical or alkoxy radical having in each case 1 to 18 C atoms, R¹ is a polymerizable group, a is 0 or 1, and n is 10 to 1000.

11. The crosslinkable reactive silicone organic copolymers of claim 1, characterized in that silicone macromers b) used are one or more from the group encompassing
α,ω-divinyl-polydimethylsiloxanes, α,ω-di(3-acryloyloxypropyl)polydimethylsiloxanes, α,ω-di(3-methacryloyloxypropyl)polydimethylsiloxanes, α-monovinyl-polydimethylsiloxanes, α-mono(3-acryloyloxypropyl)polydimethylsiloxanes, α-mono(acryloyloxymethyl)polydimethylsiloxanes, α-mono(3-methacryloyloxypropyl)polydimethylsiloxanes, and α,ω-divinyl-polydimethylsiloxanes.

12. The crosslinkable reactive silicone organic copolymers of claim 1, characterized in that ethylenically unsaturated monomers c) used are those which contain one or more further functional groups selected from the group encompassing monocarboxylic or dicarboxylic acids or their salts, monoesters of fumaric acid, monoesters of maleic acid, sulphonic acids or their salts, alcohols, amines, amides, phosphonic acids or their salts, epoxides, isocyanates or anhydrides.

13. The crosslinkable reactive silicone organic copolymers of claim 1, characterized in that monomers c) used are one or more from the group encompassing crotonic acid, acrylic acid, methacrylic acid, fumaric acid, maleic acid, ethyl fumarate, isopropyl fumarate, ethyl maleate, isopropyl maleate, vinylsulphonic acid, 2-acrylamido-2-methylpropanesulphonic acid, 2-hydroxyethyl methacrylate, hydroxypropyl methacrylate, 2-hydroxyethyl acrylate, hydroxypropyl acrylate, glycerol 1-allyl ether, 2-dimethylaminoethyl methacrylate, 2-tert-butylaminoethyl methacrylate, allyl N-(2-aminoethyl)carbamate hydrochloride, allyl N-(6-aminohexyl)carbamate hydrochloride, allyl N-(3-aminopropyl) hydrochloride, allylamine, vinylpyridine, 3-dimethylaminopropylmethacrylamide, 3-trimethylammoniumpropylmethacrylamide chloride, vinylphosphonic acid, SIPOMER PAM-100^{R} or SIPOMER 200^{R}.

14. A process for preparing crosslinkable reactive silicone organic copolymers, obtainable by means of free-radically initiated solution polymerization of a) one or more ethylenically unsaturated organic monomers, and b) one or more silicone macromers, characterized in that
c) one or more ethylenically unsaturated monomers containing at least one further functional group are copolymerized in an organic solvent or solvent mixture,
and monomer units c) of the resulting prepolymers are linked, by polymer-analogous reaction with one or more further monomers c), in such a way that at least one crosslinkable reactive group is introduced into silicone organic copolymers.

15. The process for preparing crosslinkable reactive silicone organic copolymers of claim 14, characterized in that all of components a-c), solvent and a portion of the initiator are introduced as an initial charge and the remaining initiator is metered in or added in portions.

16. The process for preparing crosslinkable reactive silicone organic copolymers of claim 14, characterized in that the entire silicone macromer b) and portions of the monomer c) in the desired proportions in the solvent are introduced as an initial charge and the remainder of the monomers, together or separately is metered in.

17. The process for preparing crosslinkable reactive silicone organic copolymers of claim 14, characterized in that the polymer-analogous reaction is carried out in the solvent or solvent mixture from the copolymerization of monomers a-c).

18. The process for preparing crosslinkable reactive silicone organic copolymers of claim 14, characterized in that the polymer-analogous reaction is carried out in one or more solvents selected from the group consisting of aliphatic hydrocarbons, aromatic hydrocarbons, ethers and esters.

19. The process for preparing crosslinkable reactive silicone organic copolymers, of claim 14, characterized in that the polymer-analogous reaction is carried out in the melt.

20. The process for preparing crosslinkable reactive silicone organic copolymers of claim 14, characterized in that, where nucleophilic monomers c) are used for preparing the prepolymers, electrophilic monomers c) are chosen for the polymer analogous reaction, or, where electrophilic monomers c) are used for preparing the prepolymers, nucleophilic monomers c) are chosen for the polymer analogous reaction.

21. An aqueous dispersion of crosslinkable reactive silicone organic copolymers, obtainable by means of free-radically initiated solution polymerization of a) one or more ethylenically unsaturated organic monomers, and b) one or more silicone macromers, characterized in that, c) one or more ethylenically unsaturated monomers containing at least one further functional group are copolymerized in an organic solvent or solvent mixture,
and monomer units c) of the resulting prepolymers are linked, by polymer-analogous reaction with one or more further monomers c), in such a way that at least one crosslinkable reactive group is introduced into silicone organic copolymers, and the copolymer is freed of the solvent, and the solid which remains is dispersed in water.

22. The use of reactive silicone organic copolymers from claim 1 as a binder or additive in crosslinkable coatings.

23. The use of reactive silicone organic copolymers from claim 1 in solvent-borne, aqueous or solvent-free adhesives, in each case either in liquid form or in powder form.

24. The use of reactive silicone organic copolymers from claim 1 as coating materials for coating wood, paper, films or metals.

25. The use of reactive silicone organic copolymers from claim 1 as hydrophobicizers or modifiers.

26. The use of reactive silicone organic copolymers from claim 1 for producing water- and/or dirt-repellant coatings, tack-free surfaces or anti-graffiti coatings.

27. The use of reactive silicone organic copolymers from claim 1 as primers and anticorrosives.

28. The use of reactive silicone organic copolymers from claim 1 as flow control agents for coatings.

29. The use of reactive silicone organic copolymers from claim 1 as binders, as cobinders or as antishrink additives in composites.

30. The use of reactive silicone organic copolymers from claim 1 for surface-modifying fibers, pigments or fillers.
